(19) United States
(12) Patent Application Publication
(10) Pub. No.: US 2017/0203342 A1
(43) Pub. Date: Jul. 20, 2017

(54) METHODS FOR SCANNING AND CLEANING TANKS

(71) Applicant: M-I Drilling Fluids UK Limited, Westhill (GB)

(72) Inventor: Martin Hunter, Aberdeen (GB)

(73) Assignee: M-I Drilling Fluids UK Limited, Westhill (GB)

(21) Appl. No.: 15/316,219

(22) PCT Filed: Jun. 30, 2015
(86) PCT No.: PCT/US2015/038488

§ 371 Date: Dec. 5, 2016

Related U.S. Application Data
(60) Provisional application No. 62/018,952, filed on Jun. 30, 2014.

(51) Int. Cl. B08B 9/093; G06T 7/73; B05B 12/12; E21B 21/01

(52) U.S. Cl. CPC B08B 9/0936; E21B 21/01; G06T 7/74; B05B 12/12; G06T 17/20

(57) ABSTRACT

A method includes scanning an interior of a tank to obtain a tank rendering. Based on the tank rendering, a minimum number of tank cleaning machines and a corresponding position for each of the tank cleaning machines is determined such that substantially all of the interior of the tank is reachable by the tank cleaning machines.

### CROSS-REFERENCE TO RELATED APPLICATION

The present application claims priority from U.S. Provisional Patent Application 62/018,952, filed Jun. 30, 2014, which is incorporated herein by reference in its entirety.

### BACKGROUND

Oilfield drilling fluid, often called “mud,” is typically a liquid having solids suspended therein. Drilling muds may contain polymers, biopolymers, clays and organic colloids added to an oil-based or a water-based fluid to obtain particular viscosity and filtration properties. Heavy minerals, such as barite or calcium carbonate, are commonly added to increase density.

The drilling mud serves multiple purposes in the industry. Among its many functions, the drilling mud acts as a lubricant to cool rotary drill bits and facilitate faster cutting rates. Typically, the mud is mixed at the surface and stored in a tank, at least a portion of which is often underground. This tank is commonly referred to as a mud tank. Mud is then be pumped from the mud tank downhole through a bore in a drillstring and returned to the surface where the mud is processed to be recirculated.

When fluids are added to a mud tank, the mud tank is cleaned to avoid cross-contamination. In circumstances where cross-contamination is not a concern, some domestic and foreign regulations call for the cleaning of mud tank. Further, cleaning a mud tank is also appropriate in order to comply with standard maintenance procedures, among many other reasons. Typically, in order to ensure a mud tank is adequately cleaned, one or more personnel enter a mud tank and manually clean the interior of the mud tank and the equipment therein using cleaning tool such as hoses and sponges, for example.

### BRIEF DESCRIPTION OF DRAWINGS

FIG. 1 shows a conventional drilling system in an oilfield.

FIG. 2 shows a side view of an interior of a mud tank in accordance with one or more embodiments of the present disclosure.

FIG. 3 shows a side view of an interior of a mud tank in accordance with one or more embodiments of the present disclosure.

FIG. 4 shows a side view of an interior of a mud tank in accordance with one or more embodiments of the present disclosure.

FIG. 5 shows a side view of an interior of a mud tank in accordance with one or more embodiments of the present disclosure.

FIG. 6 shows a method in accordance with one or more embodiments of the present disclosure.

FIG. 7 shows a side view of an interior of a tank, that includes a number of tank cleaning machines in accordance with one or more embodiments of the present disclosure.

FIG. 8 shows top view of an interior of a tank that includes a number of tank cleaning machines in accordance with one or more embodiments of the present disclosure.

FIG. 9 shows a method in accordance with one or more embodiments of the present disclosure.

FIG. 10 shows a method in accordance with one or more embodiments of the present disclosure.

FIG. 11 shows a system in accordance with one or more embodiments of the present disclosure.

### DETAILED DESCRIPTION

Embodiments are shown in the above-identified drawings and described below. In describing the embodiments, like or identical reference numerals are used to identify common or similar elements. The drawings may not be to scale and certain features may be shown exaggerated in scale or in schematic in the interest of clarity and conciseness.

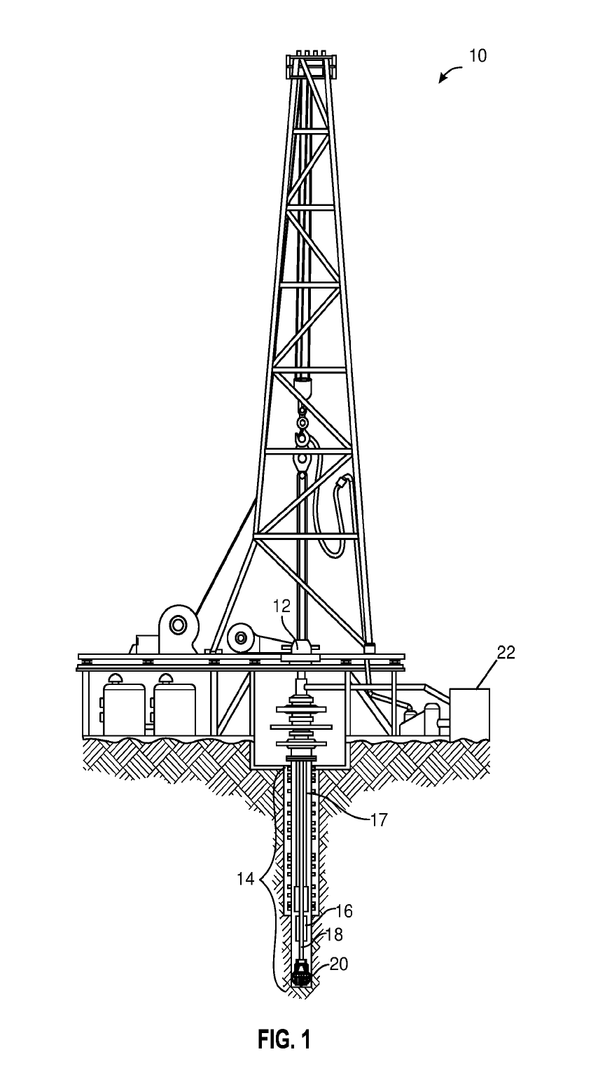

FIG. 1 shows one example of a conventional drilling system for drilling an earth formation. The drilling system may include a drilling rig 10 used to turn a drilling tool assembly 12 that extends downward into a wellbore 14. The drilling tool assembly 12 may include a drill string 16, and a bottomhole assembly (BHA) 18, which may be attached to the distal end of the drill string 16.

The drill string 16 may include several joints of drill pipe 17 connected end to end through tool joints. The drill string 16 may be used to transmit drilling fluid, or mud, (through its hollow core) to the BHA 18 and, ultimately, to bit 20. The mud may be pumped from a mud tank 22, through the drill string 16, to the bit 20. The mud tank 22 may be an open mud tank, such as a pit dug out of the ground or an open steel structure, or the mud tank 22 may be a closed tank made of steel or other resilient material.

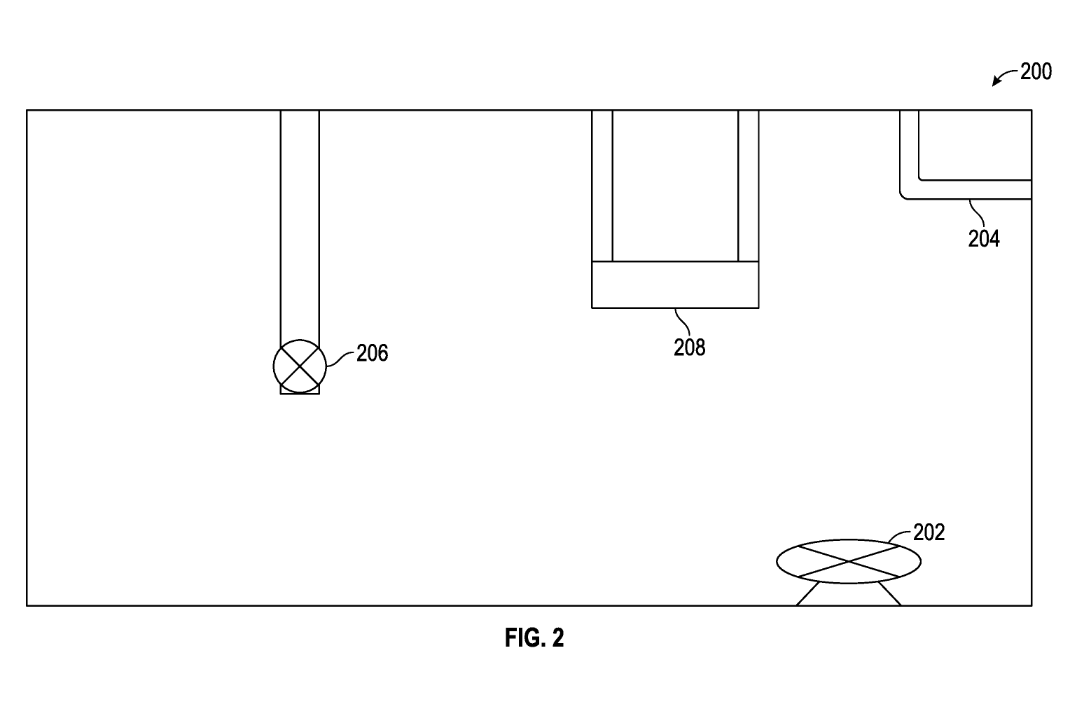

FIGS. 2-4 depict a mud tank in accordance with one or more embodiments of the present disclosure. In one or more embodiments, one or more of the modules and elements shown in FIGS. 2-4 may be omitted, repeated, and/or substituted. Accordingly, embodiments of scanning and/or cleaning tanks should not be considered limited to the specific arrangements of elements shown in FIGS. 2-4.

As shown in FIG. 2, mud tank 200 may include equipment that may be disposed along the bottom of the mud tank 200, such as agitator 202, and also may include equipment extending from the top of the mud tank 200, such as piping 204, valve 206, and support 208. Those of ordinary skill will appreciate that any other equipment known in the art may be included in the mud tank 200, such as pumps, hooks, ladders, stirrers, traps, among many others.

Each of the mud tank equipment may extend from any wall or floor of the mud tank 200, and the configuration and number of equipment used in the mud tank may depend on a particular oilfield operation or mixing process to be conducted within the mud tank. The mud tank 200 may be used to mix two or more fluids, chemicals, and/or precipitates to be used as drilling fluid, completion fluid, or any other fluid. The mud tank 200 may also be used to clean “spent” drilling fluid by separating sediment, gas, and/or cuttings, among others, from the fluid. In other circumstances, the mud tank 200 may serve as circulation and/or storage. In addition, mud tank 200 may be divided into multiple sections and each section or compartment may be used for a different purpose. For example, a section of the mud tank 200 may be used to clean spent drilling fluid, while another section of the mud tank 200 may be used to store drilling fluid.

In one or more embodiments, new or different fluids may be added to the mud tank 200. Prior to adding fluids, the mud tank 200 may be cleaned to avoid cross-contamination of fluids. Further, in circumstances where cross-contamination is not a concern, some domestic and foreign regulations may call for the cleaning of mud tank 200, such as, after a drilling operation is complete, when there is no further use for the mud tank 200, or after a certain amount of time in which the mud tank 200 has not been cleaned has passed, for example. Cleaning of the mud tank 200 may be appropriate in many other situations as well in order to avoid buildup of fluids and/or to enhance performance of the mud tank 200 and/or equipment connected to or operating within the mud tank 200, among other reasons. Those of ordinary skill will understand that there are many situations in which a mud tank may undergo cleaning.

Cleaning a mud tank may be automated in accordance with embodiments disclosed herein by using one or more tank cleaning machines to clean a portion of, a section of, or the entire interior of a mud tank. Automated tank cleaning may lower risks associated with manual labor and/or reduce the overall time to clean a mud tank resulting in less overall downtime during an oilfield operation.

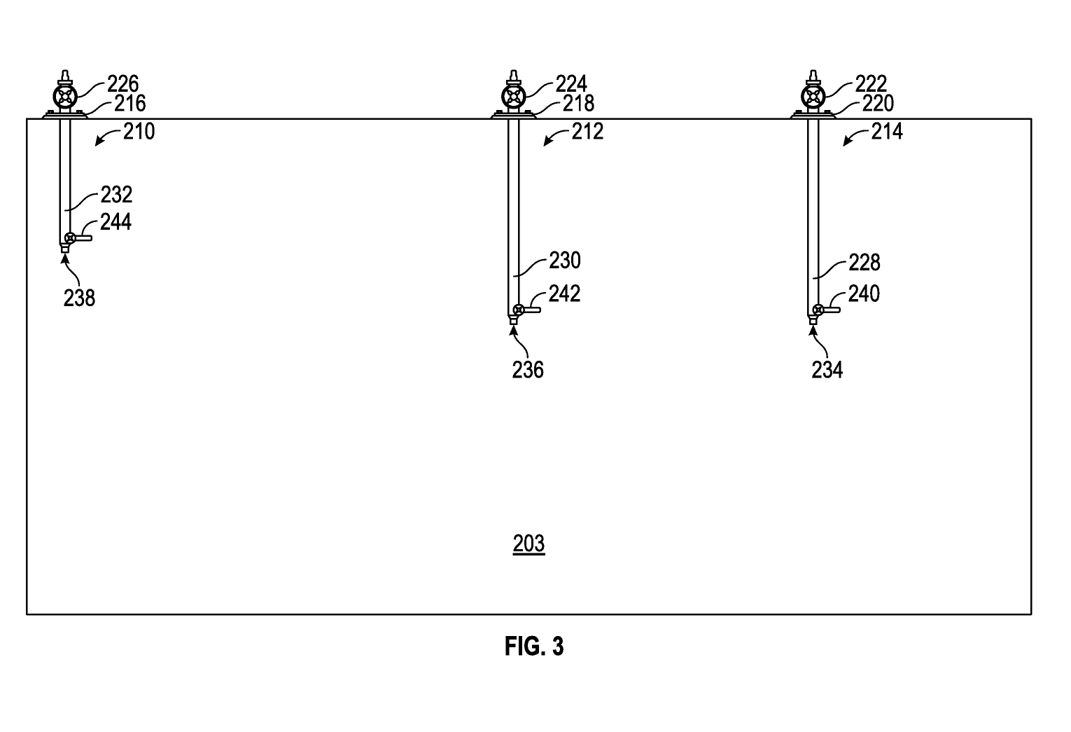

Referring to FIG. 3, an automated tank cleaning process may include placing one or more tank cleaning machines (TCMs) into the mud tank 203. A tank cleaning system may include one or more TCMs. As shown, a tank cleaning system includes TCMs 214, 212, and 210 are placed within the mud tank 203. In one or more embodiments, TCMs 214, 212, and 210 may extend inward from a top of the mud tank 203, as shown. The TCMs 214, 212, 210 may include flanges 220, 218, 216 for supporting the TCMs 214, 212, and 210. The flanges 220, 218, 216 may be disposed outside the mud tank 203, as shown, or may be disposed along the interior of the mud tank 203. TCMs 214, 212, 210 may also include pumps 22, 224, 226 that may be connected to a fluid source (not shown) for pumping fluid (e.g., water or cleaning solution) through arms 228, 230, 232 to nozzles 234, 236, 238. The nozzles 234, 236, 238 may include jets 240, 242, 244 that may be used to project a stream of fluid into the interior of the mud tank 203 in order to clean the mud tank 203.

In one or more embodiments, a stationary TCM may not allow the jets 240, 242, 244 to reach substantially all of the interior of the mud tank 203. Therefore, arms 228, 230, 232 may rotate about a longitudinal axis thereof. Similarly, jets 240, 242, 244 may rotate with respect to nozzles 234, 236, 238. Furthermore, nozzles 234, 236, 238 may rotate with respect to arms 228, 230, 232. For example, arms 228, 230, 232 may rotate 360 degrees about a vertical axis extending therethrough. Nozzles 234, 236, 238 and/or jets 240, 242, 244 may pivot 180 degrees about a distal end of corresponding arms. Further, the nozzles 234, 236, 238 and/or jets 240, 242, 244 may rotate between a range of about −90 degrees and about +90 degrees with respect a horizontal axis (i.e., the jets rotate 180 degrees with respect to a horizontal axis). Moreover, a jet may rotate in substantially any direction with respect to a point and/or an axis of extension of the TCM. Thus, the jet may rotate to substantially any direction in a spherical coordinate system.

Accordingly, by pumping fluid through the TCMs 214, 212, 210 and rotating arms 228, 230, 232, jets 240, 242, 244, and/or nozzles 234, 236, 238, a substantial portion or the entire interior of the mud tank 203 may be reachable and/or cleanable by the tank cleaning system that includes TCMs 214, 212, 210.

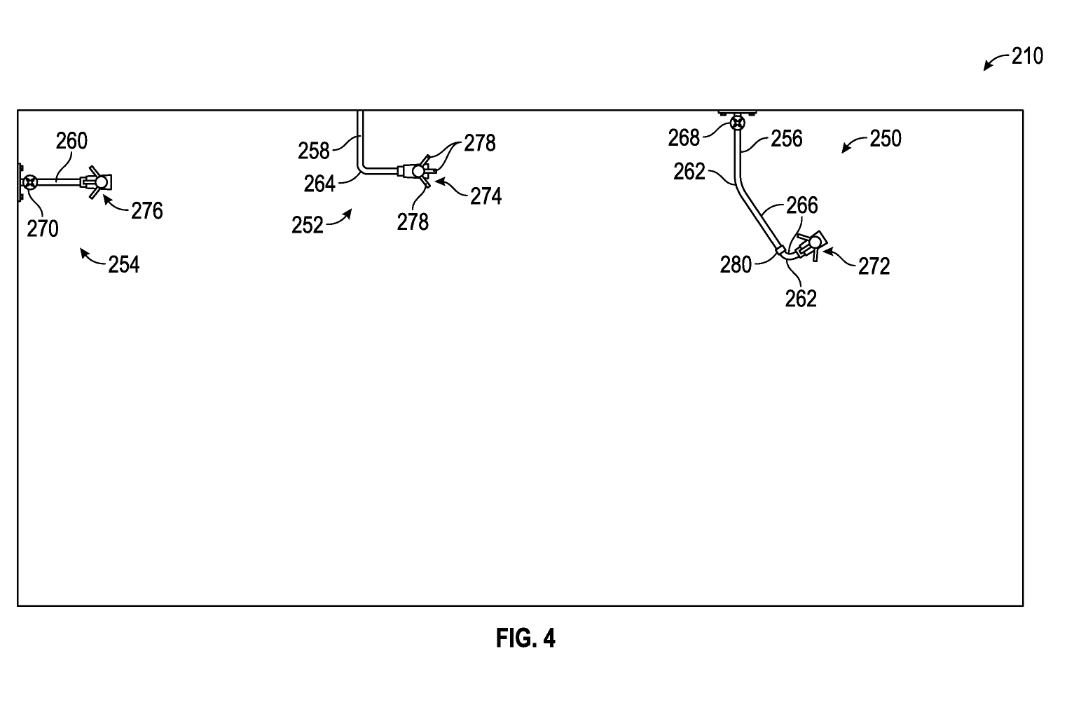

Referring to FIG. 4, an automated tank cleaning process may include placing one or more TCMs into the mud tank 210. As mentioned above, a tank cleaning system may include one or more TCMs. As shown, TCMs 250, 252, 254 are placed within mud tank 210 and may include arms 256, 258, 260 that extend inward from a surface of the mud tank 210. In particular, one or more TCMs may extend inward from a top surface of the mud tank 210, as illustrated by TCM 250 and TCM 252, for example. Further, one or more TCMs may extend inward from a side wall of the mud tank 210, as shown by TCM 254. Although not shown, one or more TCMs may extend from a bottom of the mud tank 210 or may extend from any corner of mud tank 210. As shown, arms 256, 258, 260 may extend directly (i.e., horizontally, vertically, or diagonally) into the mud tank 210. In order to avoid obstructions within the mud tank 210, arms 256, 258, 260 may include one or more bends and/or one or more extensions. For example, TCM 250 includes bends 262 and also includes arm 256 having extensions 266 connected to each other by a collar 280. In addition, one or more TCMs may include a right angle bend, such as bend 264 as illustrated by TCM 252. In addition, one or more TCMs may be fixed to a surface or a corner of mud tank 210, as illustrated by TCM 252. TCMs may also be rotatable about a pivot, such as pivots 268 and 270 as illustrated by TCMs 250 and 254. One of ordinary skill will appreciate that mud tank 210 and TCMs 250, 252, 254, are not limited to the arrangement and shapes shown in FIG. 4. For example, the mud tank 210 may be cylindrical, rectangular, and/or circular and may include angled walls and/or a slanted bottom.

In one or more embodiments, TCMs 250, 252, 254 may be equipped with one or more nozzles 272, 274, 276, respectively, and may be connected to a pump capable of forcing cleaning fluid, such as water and/or chemicals, among many others, through a jet of the nozzle. Nozzles 272, 274, 276 may include one or more jets. For example, as shown, nozzle 274 includes jets 278. Similarly, TCMs 250 and 254 each include a plurality of jets. As mentioned above, in order to clean a substantial portion of mud tank 210, the TCMs 250, 252, 254 may rotate in any direction along an axis of extension. In addition, nozzles 272, 274, 276 may also rotate about a distal end of a corresponding TCM. For example, nozzle 276 may rotate in any direction about TCM 254 and TCM 250 may rotate about an axis of extension, in this case a horizontal axis with respect to the extension of TCM 254.

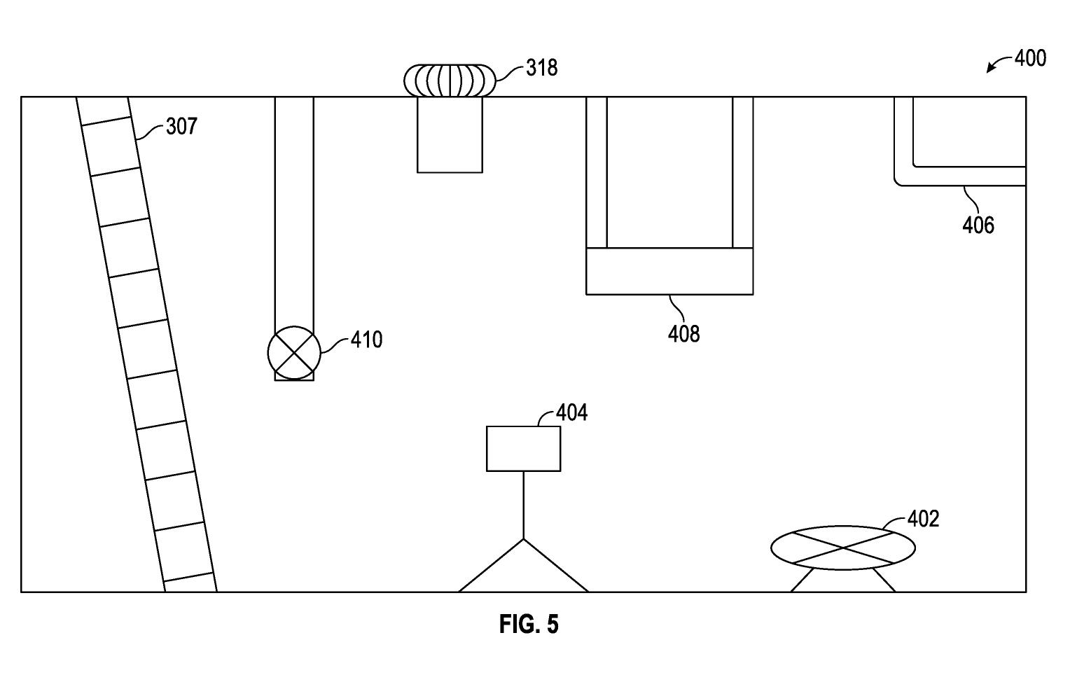

As mentioned above, in order to reach a substantial portion and in order to avoid obstructions and/or equipment within a mud tank, a tank cleaning system may include one or more TCMs, each of which may bend, rotate, and/or include multiple nozzles with one or more jets. Referring to FIGS. 5-8, obstructions in accordance with one or more embodiments are shown for illustrative purposes. One of ordinary skill in the art would appreciate that the obstructions and/or equipment within a mud tank is not limited to those shown in FIGS. 5-8.

As shown in FIG. 5, an interior of a mud tank 400 may include piping 406. The piping 406 may extend along an interior of a mud tank and may extend through one or more sections of a mud tank. The mud tank may also include support structures, such as bracket 408. One or more brackets, such as bracket 408, may be used to support piping, such as piping 406, or support any other equipment known in the art.

The interior of a mud tank may include a collar 304, a connector 306, and a ladder 307. The collar 304 may be used to connect two or more pipes to one another, or may be used to connect one or more valves (not shown) inline. Connector 306 may be used to connect two or more pipes to each other. Similar to the above, piping may extend through an interior of the mud tank and between one or more sections of a mud tank. Ladder 307 may be used for personnel access to the mud tank.

The interior of a mud tank may include a motor 314, and piping 406. Motor 314 may be used to power an agitator, a pump, a TCM, or any other equipment known in the art. Piping 406, as shown, may be used as pass through from one section of a mud tank to another.

As shown in FIG. 5, an interior of a mud tank may include an agitator 402 and a vent 318. The agitator 402 may be used to circulate or mix one or more fluids, chemicals, or precipitates with each other during operation. Vent 318 may be used during cleaning of a mud tank to aid in the removal of any harmful vapors, for example.

Those having ordinary skill in the art will appreciate that other mud tank equipment and/or obstructions may be found or used within a mud tank. Each piece of equipment and/or obstruction within a mud tank may be pertinent to the position of a TCM such that an interior of a mud tank is sufficiently cleaned by a tank cleaning system as will be described below.

Typically, the position of a TCM may be subjectively determined by an employee or contractor based on the interior configuration of a mud tank to achieve efficient cleaning of the mud tank. Often times, when a mud tank is not properly or fully cleaned using one or more TCMs, one or more personnel may manually clean the residual portions of the mud tank that were unreachable by the TCMs. Such manual cleaning may pose health and safety risks to personnel and may increase the amount of downtime during an oilfield operation. Accordingly, in accordance with embodiments disclosed herein, a number of TCMs and a corresponding position for each of the TCMs be determined that a substantial portion, or nearly all, of an interior of a mud tank is cleaned using one or more TCMs of a tank cleaning system.

FIG. 5 depicts a mud tank and a method in accordance with one or more embodiments of the present disclosure. In one or more embodiments, one or more of the modules and elements shown in FIG. 5 may be omitted, repeated, and/or substituted. Accordingly, embodiments of scanning and/or cleaning tanks should not be considered limited to the specific arrangements of elements shown in FIG. 5.

As described above, a tank cleaning system may be determined such that the interior of a mud tank is sufficiently cleaned by the tank cleaning system. For example, a number and a position of one or more TCMs of the tank cleaning system may be determined such that the interior of a mud tank is sufficiently cleaned by the tank cleaning system having one or more TCMs. As shown in FIG. 5, mud tank 400 includes a number of equipment that may obstruct the range of a tank cleaning system during cleaning. Specifically, as the range of a TCM is determined by the projection of a stream of cleaning fluid from a jet, the range of the tank cleaning system including one or more TCMs may be the total or effective range that can be covered by all of the one or more TCMs of the tank cleaning system. In one or more embodiments, the range of a tank cleaning system may be the amount or percentage of an interior area of the tank that is reachable by the stream of cleaning fluid emitted by the one or more jets of the one or more TCMs of the tank cleaning system. Therefore, the range (i.e., the amount of interior of a mud tank that is cleanable or contactable by the tank cleaning system) may differ when one or more equipment is disposed within a tank as the equipment may obstruct and/or interfere with a stream of cleaning fluid projecting from a jet of one or more TCMs during cleaning. As mentioned above and shown in FIG. 5, mud tank 400 may include an agitator 402, piping 406, valve 410, and support 408 that may act as obstructions and may limit the range of one or more TCMs. This may result in an inadequate or incomplete cleaning of the mud tank 400. As such, in one or more embodiments, the location of one or more equipment may be determined by scanning the interior of mud tank 400 using a scanning device 404 to determine a tank cleaning system, e.g., a location for the one or more TCMs, to increase, maximize, or optimize the range of the tank cleaning system.

The scanning device 404 may be a laser scanning device, a projecting device, a camera device, an infrared device, and/or any other scanning device known in the art. The scanning device 404 may be capable of obtaining a rendering of an interior of the mud tank 400. The scanning device 404 may be placed at any position along the bottom of the mud tank 400, or may extend inward from a top or a side of mud tank 400 into the mud tank 400. The scanning device 404 may scan the interior of the mud tank 404 to obtain a rendering of the interior of mud tank 404. The rendering may be a 3D rendering of the mud tank 400 and the equipment contained therein. The scanning device 400 may generate a surface mesh of the interior of the tank capable of being visualized in 3D.

In one or more embodiments, the scanning device 404 may be placed in multiple positions within the interior of mud tank 400 and may generate multiple renderings. For example, should equipment within the mud tank obstruct the scanning device 404 such that a portion of the tank rendering includes a shadowed region (i.e., a region where the equipment obstructs the projection of the scanning device), the scanning device may be moved or placed in a number of different positions within the mud tank 400 to obtain multiple tank renderings. The renderings may then be analyzed and/or combined to form a complete or substantially complete representation of the interior of mud tank 400. Further, multiple scanning devices may be placed at different positions within the mud tank 400 and each of the multiple scanning devices may obtain a tank rendering. Similarly, by combining the tank renderings generated by each of the multiple scanning devices, a complete or substantially complete representation of the interior of mud tank 400 may be formed. Using the representation of the interior of mud tank 400, a number of TCMs to be mounted in the mud tank and a corresponding position for each of the TCMs may be determined such that the range of the tank cleaning system can be increased. The range of the tank cleaning system resulting from a certain configuration of the TCMs may be evaluated using a given threshold or a percentage of total surface area of an interior of the mud tank. For example, the range may cover 80%, 90%, or greater than 95% of the total surface area of an interior of the mud tank. A processor may select a number of TCMs of a tank cleaning system suited to reach the given threshold or percentage. For example, at least 4 TCMs may be suited to reach at least 80% of the interior of the mud tank, at least 5 TCMs may be suited to reach at least 90% of the interior of the mud tank, while at least 6 TCMs may be suited to reach at least 95% of the interior of the mud tank. One of ordinary skill in the art will appreciate that the thresholds or percentages provided herein for the range of total surface area of an interior of a mud tank cleaned by a tank cleaning system or one or more TCMs are examples and are not meant to limit the scope of the present disclosure.

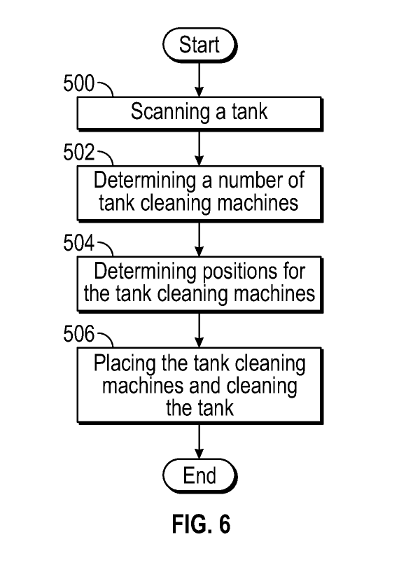

Referring to FIG. 6, a method in accordance with one or more embodiments of the present disclosure. In one or more embodiments, one or more of the modules and elements shown in FIG. 6 may be omitted, repeated, and/or substituted. Accordingly, embodiments of scanning and/or cleaning tanks should not be considered limited to the specific arrangements of elements shown in FIG. 6.

As shown in FIG. 6, a tank may be scanned at 500. The scanning of a tank may be conducted by a scanning device, such as a laser scanning device, a projecting device, a camera device, an infrared device, and/or any other scanning device known in the art. The scanning device may scan the interior of the tank to generate a rendering of the tank which may include one or more equipment devices disposed therein. The tank rendering may be a surface mesh.

Based on the tank rendering, a number of TCMs may be determined at 502, such that a substantial portion of an interior of the mud tank is reachable by the TCMs. It should be noted that a single TCM may be used in some scenarios. The tank rendering may be displayed on one or more display devices as a 3D representation and/or surface mesh of the interior of the mud tank. The tank rendering may include the equipment within the mud tank such as, but not limited to, one of agitators, pipes, walls, valves, plates, pumps, supports, and impellers disposed in the tank.

Once a number of tank cleaning machines to be mounted in the mud tank is determined, a corresponding position for each of the TCMs may also be determined at 504. The corresponding positions may be determined based on visual analysis of the tank rendering, such as analysis by one or more personnel displaying the tank rendering on a display device. In addition, the corresponding positions of each of the TCMs may also be determined based on ray-tracing techniques, such as beam ray tracing or cone ray tracing, and/or recursive ray tracing algorithms known to those of skill in the art. Further, determining a position for each of the TCMs may include determining a location, in three-dimensional space, of a jet of a TCM, such that a stream from the jet, during cleaning, is substantially free from obstructions. For example, the location of a jet of a TCM may include a plurality of coordinates of a given coordinate system. In particular, as noted above, a jet may rotate in substantially any direction with respect to a point and/or an axis of extension of the TCM. Thus, the jet may rotate to substantially any direction in a spherical coordinate system and the position of the TCM may be determined based on the stream of a jet being substantially free from obstructions in any direction in a spherical coordinate system.

In one or more embodiments, the position of a TCM may be determined by selecting a first and a second position for a given TCM. The first and second positions of the TCM may be used to determine a shadow of each of the first and second positions, such that a shadow may exist in a region that is unreachable by the TCM due to an obstruction, for example. Accordingly, comparison of the first and second shadows may be used to determine a desired location for the jet of a TCM such that a stream emitted from the jet of a TCM is substantially free of obstructions. Similarly, positions for multiple TCMs may be determined such that a stream from each of the jets of each of the TCMs is substantially free from obstructions during cleaning.

In other embodiments, a position of a TCM may be determined such that a substantial portion of an interior of mud tank is reachable by the TCM. The number and corresponding positions of TCMs may also be based on cleaning a portion of an interior of the tank. For example, the number of TCMs may include the smallest or minimum number of TCMs such that a substantial portion of an interior surface area is reachable by the number of TCMs. The substantial portion of an interior surface area may be based on a given threshold or a percentage of total surface area of an interior of the mud tank. For example, a substantial portion of the interior surface may be 80%, 90%, or greater than 95% of the total surface area of an interior of the mud tank. For example, at least 4 TCMs may be needed to reach at least 80% of the interior of the mud tank while at least 5 TCMs may be needed to reach at least 90% of the interior of the mud tank. The surface area may also include the surface area of one or more equipment disposed within the tank. Additionally, the number of TCMs in a tank cleaning system may be adjusted based on a given criteria. For example, in some cases, it may be determined that at least 4 TCMs may be suited to cover at least 80% of the interior of the mud tank, while at least 5 TCMs may be suited to cover at least 82% of the interior of the mud tank, a 2% increase. However, the 2% increase may not justify the resources that are added to place and operate 5 TCMs. Therefore, a tank cleaning system with 4 TCMs may be selected over a tank cleaning system with 5 TCMs. Accordingly, those having ordinary skill will appreciate that a number of conditions may be satisfied in order to determine a number of TCMs and a corresponding position for each of the TCMs such that an interior of mud tank is sufficiently cleaned by a tank cleaning system.

Once a number of TCMs and a corresponding position for each of the TCMs is determined, the TCMs may be placed within the tank at 506 at the determined positions to clean the interior of the mud tank, as shown, for example, in FIGS. 5 and 7-8.

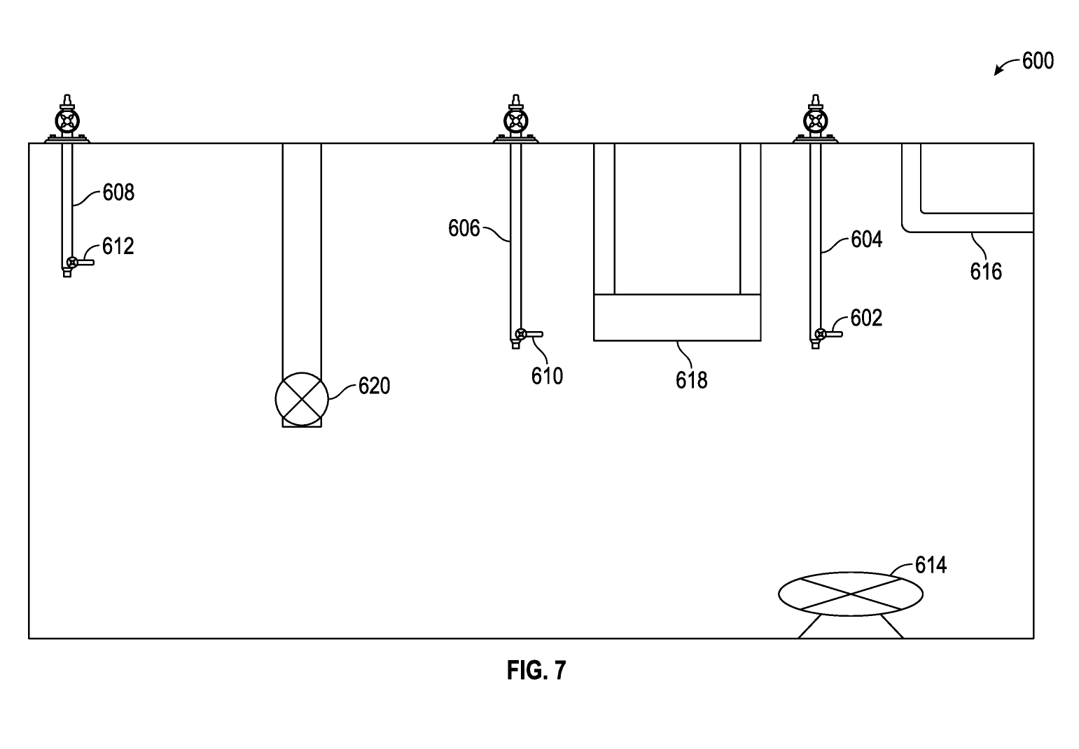

In FIG. 7, each of the TCMs 604, 606, 608 may be placed at a determined position within mud tank 600 and may include a nozzle having one or more jets 602, 610, 612. As mentioned above, the TCMs 604, 606, 608 may be capable of rotation with respect to a longitudinal axis in substantially any direction and the nozzle may be capable of rotation with respect to an axis that is perpendicular to the longitudinal axis in substantially any direction. Cleaning the mud tank 600 may include emitting a stream of fluid through the jets 602, 610, 612 of the TCMs 604, 606, 608 and rotating the TCMs 604, 606, 608 in substantially any direction such that a substantial portion of an interior of the mud tank 600 is reachable by the stream of fluid emitted by the TCMs 604, 606, 608. The fluid may include water, chemicals, and/or any cleaning fluid known in the art. In addition, the mud tank 600 may include one or more equipment, such as agitator 614, piping 616, valve 620, and support 618, among many others.

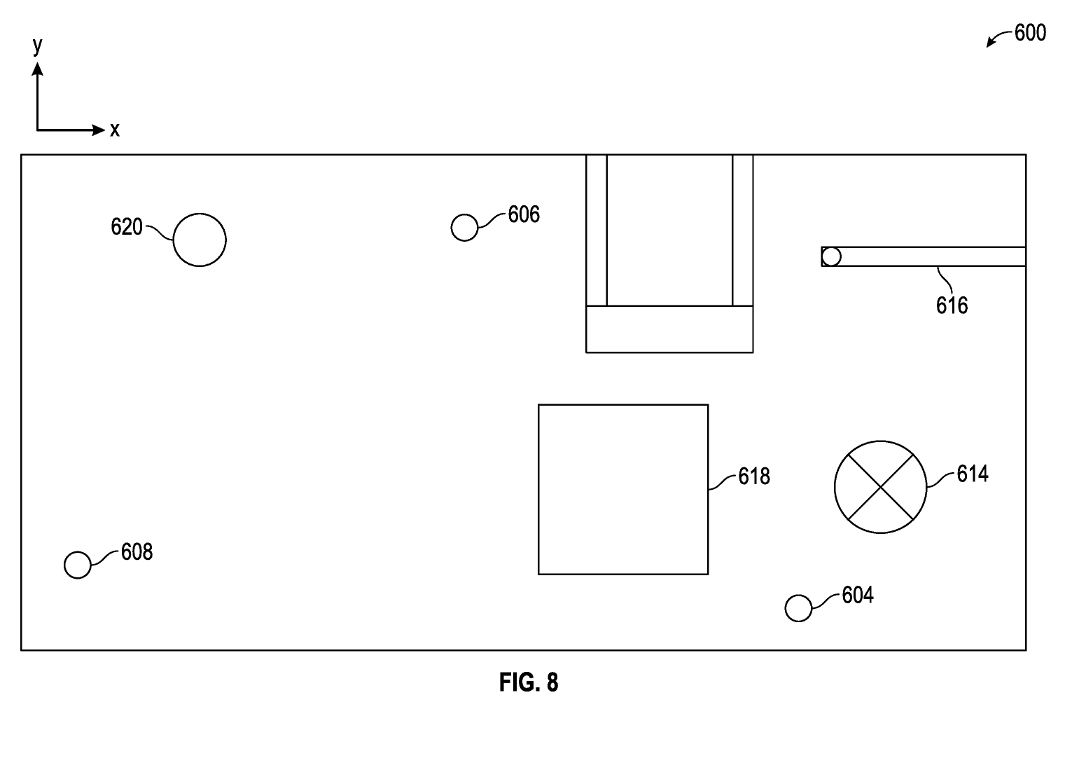

Referring to FIG. 8, a top view of a mud tank 600 is shown. Similar to the above, a number of TCMs of a tank cleaning system may be determined based on a number of obstructions or equipment, such as agitator 614, piping 616, valve 620, and support 618, for example, disposed within the mud tank 600. In one or more embodiments, a number of TCMs, such as TCMs 604, 606, 608608, of a tank cleaning system and a corresponding position along a top portion and/or surface of the mud tank 600 of each of the number of TCMs may be determined. As TCMs may be installed from a top surface of mud tank 600, the position along the top of the mud tank 600 may be determined in two-dimensions and may be represented as X-Y coordinates, for example. Once the coordinates of one or more TCMs of a tank cleaning system are determined, the one or more TCMs may be placed and cleaning jets of the one or more TCMs may clean the interior of the mud tank by emitting a stream of fluid from a point below the corresponding position along the top of the mud tank. In other embodiments, the cleaning jets may clean the interior of the mud tank by emitting a stream of fluid from a point above, adjacent to, and/or diagonally from the corresponding position. The fluid may include water, chemicals, and/or any cleaning fluid known in the art.

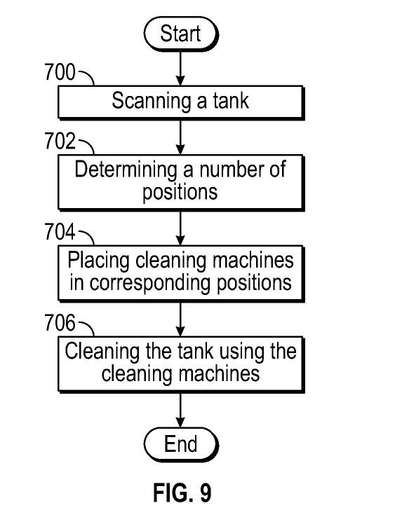

FIG. 9 depicts a method in accordance with one or more embodiments of the present disclosure. In one or more embodiments, one or more of the modules and elements shown in FIG. 9 may be omitted, repeated, and/or substituted. Accordingly, embodiments of scanning and/or cleaning tanks should not be considered limited to the specific arrangements of elements shown in FIG. 9.

In one or more embodiments, a mud tank may be scanned at 700 using a scanning device. In particular, an interior of the mud tank may be scanned by a scanning device to obtain a tank rendering. The tank rendering may include an interior top surface of the mud tank. Similar to the above, the tank rendering may include a 3D representation of the interior of the mud tank and may include a 3D surface mesh of the interior of the mud tank. The interior of the mud tank may include a number of equipment, such as, but not limited to agitators, pipes, walls, valves, plates, pumps, and impellers. Additionally, the tank may be scanned multiple times by a single scanning device or may be scanned by a plurality of scanning devices to obtain multiple tank renderings. The multiple tank renderings may be combined to form a more complete or substantial representation of an interior of the tank.

Based on the tank rendering and/or the interior top surface, a number of positions for placement of one or more cleaning jets along the top surface of the interior of the tank may be determined at 702. The number of positions may be determined such that substantially all of the interior of the tank is reachable by the one or more cleaning jets. In one or more embodiments, the number of positions of the one or more cleaning jets may be determined by calculating the smallest or minimum number of cleaning jets capable of cleaning a substantial portion of the interior of a mud tank. The substantial portion of the interior of the mud tank may be related to a given threshold and/or a percentage of the total interior surface area of the interior of the mud tank.

After a number of positions are determined for each of the cleaning jets, the cleaning jets may be placed in their corresponding positions at 704. One of ordinary skill would appreciate that the number of cleaning jets may be one. At 706, the cleaning jets may then clean the interior of the mud tank by emitting a stream of fluid from a position relative to the corresponding position. For example, the cleaning jets may clean the interior of the mud tank by emitting a stream of fluid from a point below a corresponding position on the top of the mud tank, as shown in FIG. 8, for example. The corresponding position may be determined in two-dimensions and may be represented in X-Y coordinates. A location in the mud tank of a cleaning jet of one or more TCMs may then be determined based on the corresponding position. In other embodiments, the cleaning jets may clean the interior of the mud tank by emitting a stream of fluid from a point above, adjacent to, and/or diagonally from the corresponding position. The fluid may include water, chemicals, and/or any cleaning fluid known in the art.

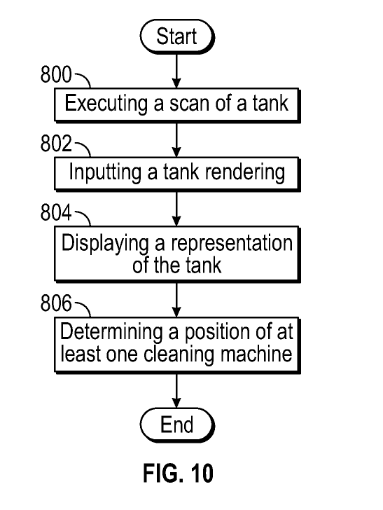

FIG. 10 depicts a method in accordance with one or more embodiments of the present disclosure. In one or more embodiments, one or more of the modules and elements shown in FIG. 10 may be omitted, repeated, and/or substituted. Accordingly, embodiments of scanning and/or cleaning tanks should not be considered limited to the specific arrangements of elements shown in FIG. 10.

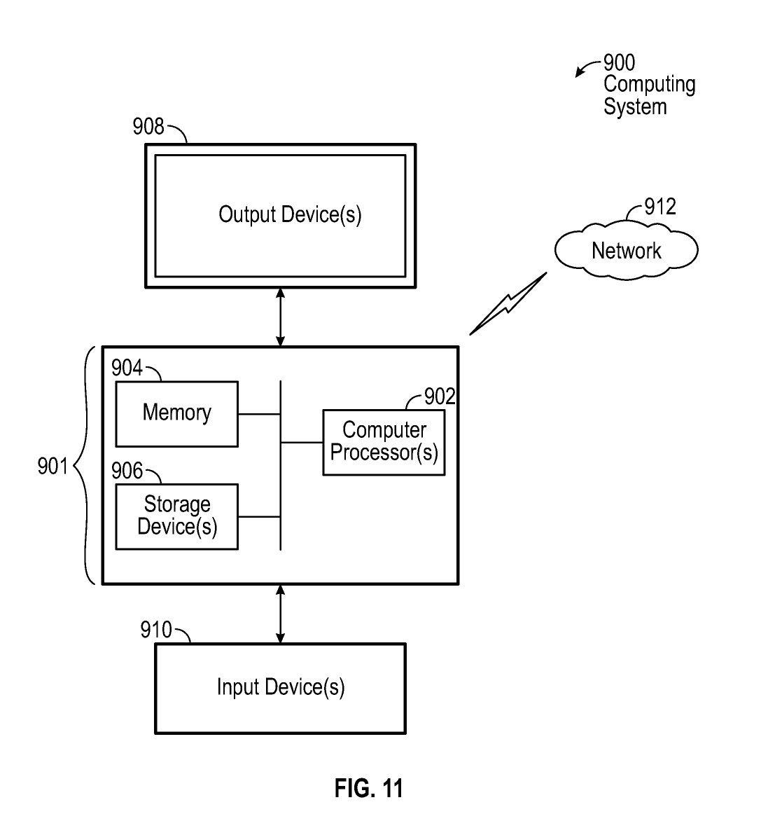

In one or more embodiments, the scanning of a tank may be executed at 800. The scan may be executed by a system (as described in FIG. 11) and the scan may be conducted by a scanning device. In particular, an interior of a mud tank may be scanned by a scanning device to obtain a tank rendering. Similar to the above, the tank rendering may include a 3D representation of the interior of the mud tank and may include a 3D surface mesh of the interior of the mud tank. The interior of the mud tank may include a number of equipment, such as, but not limited to agitators, pipes, walls, valves, plates, pumps, and impellers. Additionally, the tank may be scanned multiple times by a single scanning device or may be scanned by a plurality of scanning devices to obtain multiple tank renderings. The multiple tank renderings may be combined to form a more complete or substantial representation of an interior of the tank. The tank rendering may be used as input in a system at 802 and a representation of the tank based on the tank rendering may be displayed at 804. Based on the representation of the tank, a position of at least one tank cleaning machine may be determined at 806. The number of positions may be determined such that substantially all of the interior of the tank is reachable by the one or more cleaning jets. In one or more embodiments, the number of positions of the one or more cleaning jets may be determined by calculating the smallest or minimum number of cleaning jets capable of cleaning a substantial portion of the interior of a mud tank. The substantial portion of the interior of the mud tank may be related to a given threshold and/or a percentage of the total interior surface area of the interior of the mud tank.

Referring to FIG. 11, a system 900 includes a computing device 901 having one or more computing processors 902, one or more storage devices 906 (e.g., a hard disk, an optical drive such as a compact disk (CD) drive or digital versatile disk (DVD) drive, a flash memory stick, etc.), and memory 904 (e.g., random access memory (RAM), cache memory, flash memory, etc.). The computing processor(s) 902 may be an integrated circuit for processing instructions. For example, the computing processor(s) may be one or more cores, or micro-cores of a processor. The storage device(s) 906 (and/or any information stored therein) may be a data store such as a database, a file system, one or more data structures (e.g., arrays, link lists, tables, hierarchical data structures, etc.) configured in a memory, an extensible markup language (XML) file, any other suitable medium for storing data, or any suitable combination thereof. The storage device(s) 906 may be a device internal to the computing device 901. Alternatively, the storage device(s) 906 may be an external storage device operatively connected to the computing device 901. Additionally, the computing device 901 may include numerous other elements and functionalities.

The computing device 901 may be communicatively coupled to a network 912 (e.g., a local area network (LAN), a wide area network (WAN) such as the Internet, mobile network, or any other type of network) through wires, cables, fibers, optical connectors, a wireless connection, or a network interface connection (not shown).

The system 900 may also include one or more input device(s) 910, such as a touchscreen, keyboard, mouse, microphone, touchpad, electronic pen, or any other type of input device. Further, the system 900 may include one or more output device(s) 908, such as a screen (e.g., a liquid crystal display (LCD), a plasma display, touchscreen, cathode ray tube (CRT) monitor, projector, 2D display, 3D display, or other display device), a printer, external storage, or any other output device. One or more of the output device(s) 908 may be the same or different from the input device(s). The input and output device(s) may be locally or remotely (e.g., via the network 912) connected to the computer processor(s) (902), memory (904), and storage device(s) (906). Although the output device(s) 908 is shown as being communicatively coupled to the computing device 901, the output device(s) 908 may also be a component of the computing device 901. Many different types of systems exist, and the aforementioned input and output device(s) may take other forms.

Further, one or more elements of the aforementioned system 900 may be located at a remote location and connected to the other elements over a network 912. Further, embodiments of the disclosure may be implemented on a distributed system having a plurality of nodes, where each portion of the disclosure may be located on a different node within the distributed system. In one embodiment of the disclosure, the node may correspond to a distinct computing device. In other embodiments, the node may correspond to a computer processor with associated physical memory. The node may also correspond to a computer processor or micro-core of a computer processor with shared memory and/or resources.

In FIG. 11, the computing device 901 is capable of executing a scan of an interior of a tank. The scan may include obtaining a tank rendering of an interior of a mud tank using a scanning device. The scanning device may obtain a tank rendering to be used as input for computing device 901, for example. The tank rendering may be input using one or more input devices 910 and stored for later access in at least one of the memory 904 and the storage devices 906. Thereafter, the tank rendering may be displayed, as a three-dimension representation, for example, using one or more output devices 908. Using the computing device 901 and/or one or more computer processor 902, a position for at least one tank cleaning machine may be determined based on the tank rendering input. The range of an interior surface area of the mud tank that is covered by the tank cleaning system may be evaluated by the computing device 901 for a given arrangement of the TCMs. For example, the computing device may determine that the range is 80%, 90%, or greater than 95% of the total surface area of an interior of the mud tank for a given arrangement of the TCMs. Based on the determination of the computing device 901 (i.e., resulting percentage in this embodiment), the number or the positions of TCMs of a tank cleaning system may be adjusted to bring the range closer to a given threshold. For example, at least 4 TCMs may be suited to reach at least 80% of the interior of the mud tank, at least 5 TCMs may be suited to reach at least 90% of the interior of the mud tank, while at least 6 TCMs may be suited to reach at least 95% of the interior of the mud tank.

As mentioned above, the tank cleaning machine may include one or more jets that emit a stream of fluid and are capable of rotating in substantially any direction. One of ordinary skill in the art would appreciate that the positions for more than one tank cleaning machine may be calculated and thus, a plurality of tank cleaning machines and corresponding positions may be determined using the system 900.

Embodiments of the present disclosure, therefore, may allow adequate cleaning of a mud tank by determining the number and corresponding positions for one or more tank cleaning machines. Further, embodiments of the present disclosure may allow for an efficient, safe, and resource saving approach to cleaning mud tank in the oilfield. Additionally, whether the mud tank is located on shore or offshore, the process of cleaning of one or more sections of a mud tank may be done safely and efficiently without a labor-intensive manual cleaning process.

Software instructions in the form of computer readable program code to perform embodiments of the present disclosure may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the present disclosure. Further, portions of the systems and methods may be implemented as software, hardware, firmware, or combinations thereof.

One or more embodiments of the present disclosure relate to a method including scanning an interior of a tank to obtain a tank rendering, and determining, based on the tank rendering, a minimum number of tank cleaning machines and a corresponding position for each of the tank cleaning machines such that substantially all of the interior of the tank is reachable by the tank cleaning machines.

One or more embodiments of the present disclosure relate to a method including scanning an interior of a tank to obtain a tank rendering, the tank including an interior top surface, determining, based on the tank rendering, a number of positions on the top surface for cleaning jets such that substantially all of an interior area of the tank is reachable by the cleaning jets, placing each of the cleaning jets in the corresponding position, and cleaning the interior of the tank using the cleaning jets, each of the cleaning jets configured to emit a stream of fluid from a point below the corresponding positions in substantially all directions.

One or more embodiments of the present disclosure relate to a method including executing a scan to generate a tank rendering, inputting the tank rendering on a computer, displaying a three-dimensional representation of the tank rendering, and determining, by the computer, a position for at least one tank cleaning machine based on the three-dimensional representation of the tank rendering.

Although the preceding description has been described herein with reference to particular means, materials and embodiments, it is not intended to be limited to the particulars disclosed herein. Rather, it extends to all functionally equivalent structures, methods and uses, such as are within the scope of the appended claims.

What is claimed:

1. A method comprising:
scanning an interior of a tank to obtain a tank rendering; and
determining, based on the tank rendering, a minimum number of tank cleaning machines and a corresponding position for each of the tank cleaning machines such that substantially all of the interior of the tank is reachable by the tank cleaning machines.

2. The method of claim 1, further comprising:
placing each of the tank cleaning machines in the corresponding position; and
cleaning the tank using the tank cleaning machines.

3. The method of claim 2, wherein cleaning comprises emitting a stream of fluid from a jet of each of the tank cleaning machines in substantially any direction of a spherical coordinate system.

4. The method of claim 1, further comprising graphically displaying the tank rendering as a three-dimensional surface mesh of the tank and at least one of agitators, pipes, walls, valves, plates, pumps, and impellers disposed in the tank.

5. The method of claim 1, wherein the minimum number of tank cleaning machines is one.

6. The method of claim 1, wherein the determining comprises:
selecting a first position and a second position for one of the tank cleaning machines;
determining a shadow of the first position and a shadow of the second position; and
comparing the shadow of the first position and the shadow of the second position to determine a desired position.

7. The method of claim 1, wherein the determining comprises determining a location of the tank cleaning machine such that a stream from the tank cleaning machine is substantially free of obstructions.

8. The method of claim 1, wherein the scanning of the interior of the tank is performed by a scanning device comprising at least one selected from a group consisting of a projecting device, a laser scanning device, and a camera device.

9. The method of claim 1, wherein the tank comprises a mud tank and is located at a drilling site.

10. The method of claim 1, wherein the tank cleaning machines are positioned such that a substantial portion of surface area of the tank is reachable by the tank cleaning machines.

11. The method of claim 10, wherein the substantial portion of surface area is greater than a given threshold.

12. The method of claim 11, wherein the threshold is expressed as a percentage of total surface area of the tank that is covered by the tank cleaning machines.

13. The method of claim 1, wherein the minimum number of tank cleaning machines is determined using a ray tracing technique.

14. The method of claim 1, wherein determining comprises determining a plurality of coordinates for placement of a jet of the tank cleaning machine.

15. A method comprising:
scanning an interior of a tank to obtain a tank rendering, the tank including an interior top surface;
determining, based on the tank rendering, a number of positions on the top surface for cleaning jets such that substantially all of an interior area of the tank is reachable by the cleaning jets;
placing each of the cleaning jets in the corresponding position; and
cleaning the interior of the tank using the cleaning jets, each of the cleaning jets configured to emit a stream of fluid from a point below the corresponding positions in substantially all directions.

16. The method of claim 15, wherein the tank comprises at least one selected from a group consisting of agitators, pipes, walls, valves, plates, pumps, and impellers disposed in the tank.

17. The method of claim 15, wherein determining the number of cleaning jets comprises calculating a minimum number of cleaning jets such that substantially all of the interior of the tank is reachable by the cleaning jets.

18. A method comprising:
executing a scan to generate a tank rendering;
inputting the tank rendering on a computer;
displaying a three-dimensional representation of the tank rendering; and
determining, by the computer, a position for at least one tank cleaning machine based on the three-dimensional representation of the tank rendering.

19. The method of claim 18, wherein determining the position of at least one tank cleaning machine comprises maximizing a reachable region based on a number of the at least one tank cleaning machine.

20. The method of claim 19, wherein the reachable region is a region of the tank that is reachable by a stream from each jet of the plurality of tank cleaning machines.
